(19) United States
(12) Patent Application Publication
(10) Pub. No.: US 2016/0247115 A1
(43) Pub. Date: Aug. 25, 2016

(54) AIRBORNE SCANNING SYSTEM AND METHOD

(71) Applicant: Jasper Mason PONS, Hillcrest (ZA)

(72) Inventor: Jasper Mason PONS, Hillcrest (ZA)

(21) Appl. No.: 14/902,385

(22) PCT Filed: Jun. 26, 2014
(86) PCT No.: PCT/ZA2014/000029

§ 371 Date: Dec. 31, 2015

(30) Foreign Application Priority Data
Jul. 2, 2013 (ZA) 2013/04917

(51) Int. Cl. G06Q 10/08; G06K 7/14; G05D 1/00; G06K 7/10

(52) U.S. Cl. CPC G06Q 10/087; G06K 7/10376; G06K 7/1413; G05D 1/0094

(57) ABSTRACT

A scanning system for scanning data from a plurality of data records (for example barcodes or RRD tags) comprises at least one Unmanned Aerial Vehicle (UAV) 100 and at least one scanner (not shown) mounted on said UAV 180 and adapted to scars said data records, thereby to extract data from said data records. The system may include remote control means operable to control the UAV, and an imaging system for transferring video feed from the UAV to a controller location in spaced relation to the UAV. A position controller and method of scanning are also provided.

### TECHNICAL FIELD

THIS INVENTION relates to an airborne scanning system and method suitable for scanning barcodes and other data records.

### BACKGROUND ART

Stock take (also known as “physical inventory”) is frequently done in warehouses. Stock take is not a daily operation; it is usually done once per year as a minimum, sometimes monthly, and often quarterly.

It is the physical verification of items in warehouses. Each and every item has to be meticulously verified and its position in the warehouse recorded on paper or directly into a computer system. Any items not found are “written off” and there is a financial implication to items “written off,” so stock take is a type of “reset” or “spring clean” of a warehouse.

Because stock take cannot be done when materials are moving in and out of the warehouse, the business in question normally closes for normal operation during stock take. Stock take is normally done on weekends so as not to affect business; hence stock takes are often confined to two days, or seven eight hour shifts if working right through. Large warehouses have worked out how long it takes to do stock take and hire in as many staff as are needed to perform the stock take within the seven shifts.

Typically, stock takes rely on the scanning of barcodes present on items. In warehouses where there are multiple boxes placed on top of each other, or there are high racks containing items that need to be scanned, the barcodes are out of reach of the personnel doing the stock take. Typically, anything over 2 m high cannot be scanned by normal means. The main methods used to perform scanning of high items include:

Use of long range scanners. These are high powered barcode scanners using a powerful laser to carry out the scanning. A user can scan from the ground. Such devices suffer from shortcomings, however. The scanners can be expensive, not robust and too heavy for daily use, may have a short battery life and a limited range, may be inaccurate for closely packed barcodes, may have limited availability (being specialized equipment), and typically have slow operation speeds.

Moving of boxes. In some cases, a forklift can bring boxes down to be scanned.

While this process has advantages (for example, that hidden boxes can be exposed), it also has its shortcomings. The process is slow and dangerous, involving large volumes of items moving up and down. Significant quantities of forklift fuel are needed. Damage can be caused by forklift movement, especially to small boxes.

Moving of people. A special safety cage can be fitted to forklifts and one or two people can be lifted up to each box in turn to scan the barcode. The shortcomings of this approach are that it requires extra staff including forklift drivers, and requires forklifts which are expensive to maintain. There is an increased risk of damage caused by forklift movement. Also, this process can be slow—the cage has to be lowered when the forklift moves down the aisle, for safety reasons.

There are other technologies which do not rely on barcodes; however these technologies have not been widely adopted, mostly because of price. The following are some of these other technologies:

Passive RFID tags. These tags can be scanned from a range of 2 cm to 6 m (depending on the technology used) using portable and fixed scanners. The scanner itself generates the energy for the tag communication; the tag does not contain a battery. The scanners are relatively expensive. The passive tags require a user to scan the RFID tag and assign it to its bin location by scanning the bin location. It is generally not feasible to place a passive RFID reader under each bin location to monitor the contents of each bin. The cost of an RFID reader powerful enough to read at a range of 1 m can become prohibitive in a warehouse containing 100 000 locations.

Active RFID tags. These tags are more expensive. They contain a battery that lasts approximately 5 years. They can be scanned from a range of 200 m using fixed scanners. Active tags cannot be used for location information because all tags within a 200m radius may be picked up and it is difficult to determine which tag is located in which bin location.

Grid concepts, e.g. WiFi RFID. This system employs a grid of receivers to determine the location of RFID tags by determining the relative proximity of the tag to multiple receivers in the grid using triangulation. The system needs a complete network of calibrated multiple access points to perform the triangulation.

The overwhelming reason that most companies remain with barcodes is cost. They cannot justify the additional cost of RFID tags on items. Also, since most items already have a human readable label on them, a barcode requires little extra effort to create.

RFID has a further disadvantage in that, on its own, it can only provide half of the information required for a stock take. It can only determine the presence of an item. It cannot determine the location of that item and therefore still requires a manual scanning process. RFID is not suitable for determining position information because of “noisy scans”—multiple items can be scanned at once and the user might not be sure of which one is in which location.

There are other technologies available for use in warehouses, such as in-rack pallet shuttles, moveable racking, and on-demand automatic storage and retrieval systems; however these systems typically only address warehouse space issues and do not improve the efficiency, accuracy and speed of stock take.

There is a continuing need for alternative systems that are capable of scanning high boxes during stock takes in warehouses, and especially for systems allowing quicker and safer methods of carrying out stock taking than have hitherto been provided by traditional methods.

### DEFINITIONS

CAD means Computer Aided Design—Software used to draw items on a computer.

CNC means Computer Numerical Control—A machine that can automatically cut shapes out using high speed, rotating cutting and drilling tools.

FCU means Flight Control Unit—A computer that controls the flight stability of an airborne craft such as a UAV, and which is typically adapted to respond to remote control commands and to adjust speed and direction of the craft by controlling at least one motor and/or control surface. An FCU typically comprises an IMU (see below).

FPV means First Person View. This refers to a camera mounted on something, for example a UAV, that transmits live video back to a pilot for purposes of remote steering and control.

GPS means Global Positioning System.

HF means the high frequency range of the radio spectrum, i.e. the band extending from 3 to 30 MHz.

IPS means Indoor Positioning System.

IMU means Inertial Measurement Unit—A device consisting of gyroscopes and accelerometers that measures acceleration and angle of tilt. It can be used to calculate how far an object has moved by integrating acceleration over time, however it tends to lose accuracy over time and needs to have its position reset by some other means e.g. reference points or GPS.

MSP means MultiWii Serial Protocol.

Multi Rotor means a flying vehicle with more than one rotor, each rotor being mounted for rotation about a generally vertical axis. A helicopter has one main rotor, but UAVs with two, three, four, six or eight rotors are known. Each rotor is typically computer controlled. Steering and stability are usually accomplished by spinning each rotor at a slightly different speed—typically controlled by a central onboard computer (e.g. an FCU).

Quadcopter means a flying radio-controlled model (UAV) which has four rotors mounted for rotation about four generally vertical axes, each rotor typically being computer controlled. It is capable of hovering and maneuvering.

RFID means Radio Frequency Identification. This refers to the use of a tiny chip that can be scanned with a scanner in a way similar to a barcode; however it can be scanned from distances of 4 m, and up to 200 can be scanned in one second.

Stock Take is a term used in many organizations and refers to a physical count of how many of each product an organization has on hand. After the physical count, the organization's computer systems are normally adjusted to represent the physical quantity on hand. Stock take is sometimes also called “Physical Inventory” or just “Inventory”.

Tricopter means a flying radio-controlled model (UAV) which has three rotors mounted for rotation about three generally vertical axes, each rotor typically being computer controlled. It is capable of hovering and maneuvering.

UAV means an Unmanned Aerial Vehicle. A UAV is an unmanned vehicle capable of flight that can be flown by remote control and/or autonomous onboard control.

UHF means the ultra-high frequency range of the radio spectrum, i.e. the band extending from 300 MHz to 3 GHz.

### DISCLOSURE OF THE INVENTION

According to a first aspect of the invention there is provided a scanning system for scanning data from a plurality of data records that are mutually spaced from one another, characterized in that said system comprises

at least one Unmanned Aerial Vehicle (UAV);

at least one scanner mounted on said UAV and adapted to scan said data records thereby to extract data from said data records.

The scanning system may include remote control means operable to control the UAV.

Preferably the airborne scanning system includes an imaging system for transferring images from the UAV to a controller location in spaced relation to the UAV. The imaging system may include means for capturing and transferring images selected from the group consisting of still images and live video feed. The imaging system may include at least one video camera mounted onboard the UAV.

The system may include a mobile base station comprising data processing means and data collection software, for recording the extracted data from the data records, optionally in real time. The software may also be adapted to provide derived information that has been calculated using the scanned data, for example information that could be used by an operator to monitor the accuracy of a stock take process.

The system may include transmission means for transmitting the extracted data and optionally also the video feed from the UAV to the base station. The transmission means are preferably wireless transmission means, for example WiFi or other radio transmission means. However, a towed cable falls within the scope of the invention as a means for transmission.

The data records to be scanned may be selected from the group consisting of barcodes and Radio Frequency Identification (RFID) tags. The barcodes may be of the one-dimensional configuration or the two-dimensional configuration also known as matrix barcodes or “QR” codes.

The scanner may be selected from the group consisting of barcode scanners (of the type suitable for scanning one-dimensional and/or two-dimensional barcodes), and RFID scanners. Where the barcodes to be scanned are of the two-dimensional type, the scanner may include at least one camera as well as software for interpreting the barcode.

A single UAV may include a plurality of scanners. Furthermore, different types of scanner may be present onboard a single UAV. For example a UAV may carry both barcode and RFID scanners.

The system may include ancillary components selected from the group consisting of autonomous flight control means for controlling the flight and scanning operations of the UAV according to predetermined patterns and without the need for constant user input; altitude detection and control means; collision detection means; processing means and computer software for managing operation of said scanner; and a plurality of visual proximity indicators to serve as location indicators, with proximity measuring means mounted on said UAV for reading said visual proximity indicators.

A scanning system according to this invention may include just one UAV or a plurality of UAVs.

Preferably the (or each) UAV is configured to be balanced irrespective of how many of the above components are mounted on it, so that its flying characteristics remain even.

Advantageously the (or each) UAV should be capable of maintaining a hover.

According to a further aspect of the invention there is provided a position controller for use in controlling the operation and position of an Unmanned Aerial Vehicle (UAV), said UAV forming part of a scanning system which includes a Flight Control Unit (FCU) and data input sources, characterized in that said position controller comprises:

at least one microprocessor;

software adapted to be executed by said microprocessor, for receiving and processing input from said data input sources, thereby to determine a location of the UAV in space and a location in space to which it should next move, and also to adjust and update the desired location in space of the UAV based on said input, and to generate flight control commands for the FCU; and

data transmission means for passing said flight control commands to the FCU for subsequent implementation by the FCU.

The position controller may be adapted to control the UAV autonomously or partially autonomously.

The software of the position controller may additionally be adapted to receive and process operator adjustments.

The data input sources may be selected from the group consisting of height sensors, range sensors, scanners for scanning data records, preset settings and command processing means. The range sensors may in turn be selected from the group consisting of infrared sensors, sonar (ultrasonic) sensors, optical flow sensors and laser range finders. As before, the scanners may be selected from the group consisting of barcode scanners and RFID scanners.

The scanning system may include additional data input sources, for example location indicators mounted externally of, and separate from, the UAV; and sensors selected from the group consisting of gyroscopic sensors and accelerometers; and in such cases the software of the position controller may be adapted to receive and process data from said additional data input sources.

The software for the scanning system is preferably coded using an object-oriented programming language.

According to a further aspect of the invention there is provided a method of scanning a plurality of data records which are mutually spaced from one another, characterized in that said method comprises the following steps:

providing an Unmanned Aerial Vehicle (UAV) which includes at least one scanner adapted to scan said data records thereby to extract data from said data records;

operating said UAV; and

scanning said data records with said scanner.

The method may comprise the following additional steps: providing remote control means operable to control the UAV; and controlling the UAV with said remote control means.

Typically, the UAV is provided with at least one position controller, at least one Flight Control Unit (FCU) and data input sources including at least one height sensor; and in this case the method may comprise the following additional steps:

operating said FCU under command from the position controller, thereby to fly the UAV in a generally vertical direction until a predetermined height is reached, as determined by input received from the height sensor and processed by said position controller;
operating said FCU under command from the position controller, thereby to fly the UAV in a first generally horizontal direction;

operating said FCU under command from the position controller, thereby to fly the UAV in a second generally horizontal direction aligned transversely to said first generally horizontal direction.

As an example of how these steps could be implemented, the UAV could be flown from the floor of a warehouse up to a desired level of racks or shelves, then flown left or right to line up on a particular box or shelf requiring scanning, then moved inwards towards the box or shelf until the UAV's scanner or scanners come within range to permit scanning.

The data records to be scanned are typically located according to a spatial configuration. The method may comprise the following additional steps:

providing a base station in spaced relation to the UAV, said base station being adapted to access information regarding said spatial configuration of the data records;

interrogating said base station to access said information;

transferring said information to the position controller; and

operating the position controller in such a manner that said information is included in its determinations regarding the flight of the UAV in at least one of said directions.

The configuration of the data records may, for example, be related to the positioning of boxes on racks in a warehouse, or shipping containers stacked in a port or onboard a vessel. These applications are given as examples only and those skilled in the art will appreciate that numerous other applications (and hence configurations) also fall within the scope of the invention.

As before, the scanner or scanners may be selected from the group consisting of barcode scanners and Radio Frequency Identification (RFID) scanners.

The scanning system and method described herein may have certain advantages over other scanning systems used for warehouse stock taking. For example, the barcode scanners carried by the UAVs of the present system are flown up to the barcodes by the UAV. Data records may therefore be scanned significantly faster than the rate at which persons scanning manually can do similar work. This in turn may lead to quicker stock takes requiring less labour and allowing for quicker resumption of normal business activities.

Even if the flying scanners (UAVs) only carry out scanning of high boxes, it could add important savings.

Safety benefits are also expected. Human workers do not need to be moved up and down, and heavy pallets do not need to be moved around. Forklifts do not need to drive around risking collisions with personnel.

Capital costs are likely to be reduced. A flying scanner (UAV) is cheaper than a forklift with its cage, and roughly similar in cost to a long range scanner. Also, there is less need for fixed infrastructure, especially in the simpler embodiments of the invention where only the system itself is required along with some low cost navigation or location indicator labels stuck to the racking and/or boxes.

Running costs may be reduced. The costs of operating a flying scanner (UAV) are mainly the costs of charging its batteries, providing spares for the system components, and paying skilled labour time. It is anticipated that these costs will be less than the fuel costs of running forklifts, for example.

### BRIEF DESCRIPTION OF THE DRAWINGS

The invention will now be described by way of non-limiting example, with reference to and as illustrated in the accompanying diagrammatic drawings.

In the drawings (which are not to scale):

FIG. 1 shows, schematically, a front perspective view of a UAV forming part of the scanning system according to the invention;

FIG. 2 shows, schematically, a plan of said UAV;

FIG. 3 shows, schematically, a front end of said UAV, with detail of a mounting plate for scanner and sensors;

FIG. 4 shows, schematically, a portion of said UAV, with detail of a central boss, external hub and stay wires which extend under tension between the central hub and frame arms;

FIG. 5 illustrates a partial object model showing some of the classes that may be required by a position controller for a UAV, in order to perform its functions;

FIG. 6 shows, schematically, a flowchart for use by a position controller when finding items; and

FIG. 7 shows, schematically, a flow diagram for an example of navigation functionality to be conducted semi-autonomously by a UAV performing its tasks along a section of racking in a warehouse.

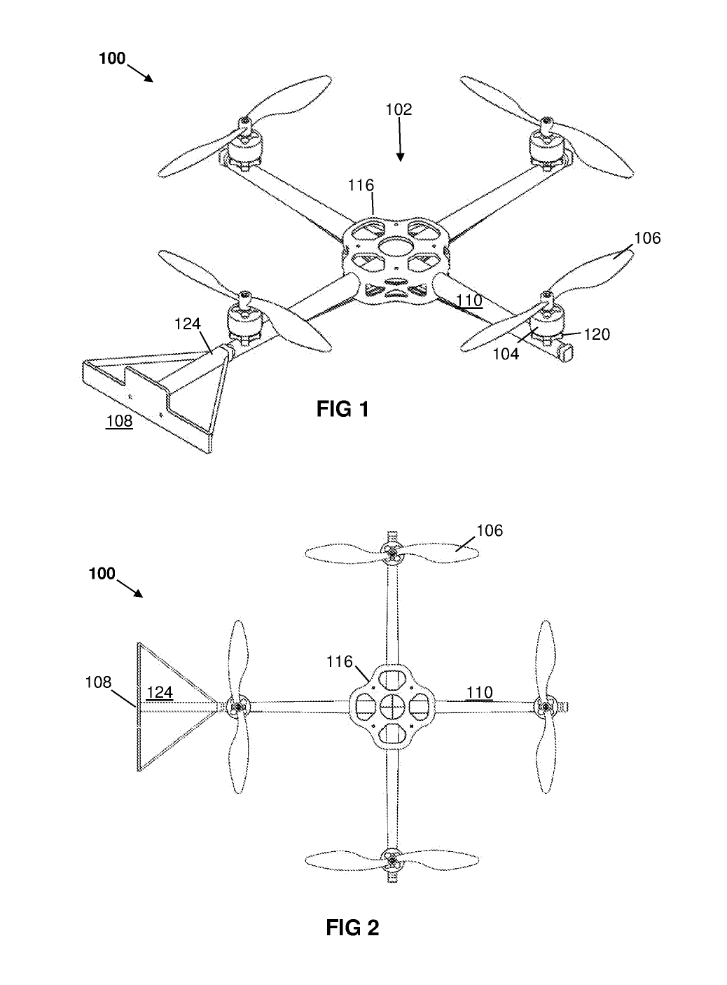

### MODES FOR CARRYING OUT THE INVENTION

An example of a scanning system according to the invention includes the following basic features: a UAV having a mounted barcode and RFID scanner; a base station; pilot equipment; and a power source.

The above basic features are discussed in further detail below:

A: UAV

The UAV is an unmanned aerial vehicle, typically consisting of a battery, flight control computers, motors, propellers or rotors, an airframe, and radio equipment. The UAV should preferably be capable of sustaining stabilized, hovering flight in a confined environment.

Advances in model aircraft technology have made possible electric powered computer controlled flying vehicles capable of carrying a payload of up to 1 kg.

A preferred type of UAV for the present invention is a multi rotor. This is a battery operated flying craft which is approximately 0.5 m in diameter and has a number of equal-sized rotors mounted on generally vertical axes. It also has a flight control computer to stabilize the craft's flight and to allow for hovering, and radio control means for moving it around.

Tricopters, which have three rotors, were assessed in early development of the present invention because of their greater field of view compared with quadcopters. However, the inventor found that tricopters are less suited to purpose than quadcopters because of difficulties associated with yaw control and other factors.

Lightweight barcode scanners (weighing approximately 50 g and smaller than 27 cm³) are available. The lightweight properties of such scanners open up the possibility of deploying multiple mounted scanners on a single UAV, thereby improving scanning speed and accuracy.

Apart from the preferred quadcopter configuration and the tricopter configuration, various other configurations of multi rotors are available and fall within the scope of the invention. These include, without limitation, bicopters, hexacopters and octocopters.

A purpose built airframe is advantageous, having the capability of carrying the scanning and sensing equipment. Traditional multi rotor airframes are designed to carry cameras and not close-proximity barcode scanners. Therefore, a bespoke airframe was developed for purposes of this invention, having fittings customized for mounting a scanner and sensors.

The design of the UAV is minimalistic to make assembly and maintenance easier and to reduce weight. The preferred UAV is a purpose-built quadcopter flying in a “+” configuration (with one motor in front), with a single mounting plate out front for the scanner and sensors. Having only one motor in front means that the scanner can be positioned close to the racking with only one propeller in proximity. This reduces the risk of a propeller striking the racking and also reduces acoustic and electrical interference from the propellers onto the sensors.

Rather than having a single carbon fibre shell for the airframe and mountings, a modular design is preferred. This makes repairs cheaper because only broken components needs to be replaced, not the whole frame. In addition, because the design needs to be extremely symmetrical in the air to prevent “drift” while navigating, it is easier to make design adjustments to an assembled modular design than a monocoque frame, which, if the mould is out of alignment, might mean that the entire mould has to be scrapped and re-made. In a modular design, only the offending part needs to be re-made.

Referring to the drawings, reference numeral 100 indicates generally a possible layout of a UAV for the scanning system. The UAV 100 has the configuration of a quadcopter but other embodiments can be based on other multi rotor configurations (for example a tricopter). The UAV 100 has an integrated structure comprising an airframe generally indicated by reference numeral 102, a propulsion system comprising four motors 104 driving propellers or rotors 106, and mountings for electronic equipment for scanning, sensing and flight control (including a mounting plate 108).

The motors 104 are preferably electric motors of the brushless type, with direct drive to their rotors. Preferably the UAVs of the invention should each have sufficient power to lift a load of 400 g for a minimum of 7 minutes.

The airframe 102 includes a basic frame defined by four hollow motor supports or frame arms 110.

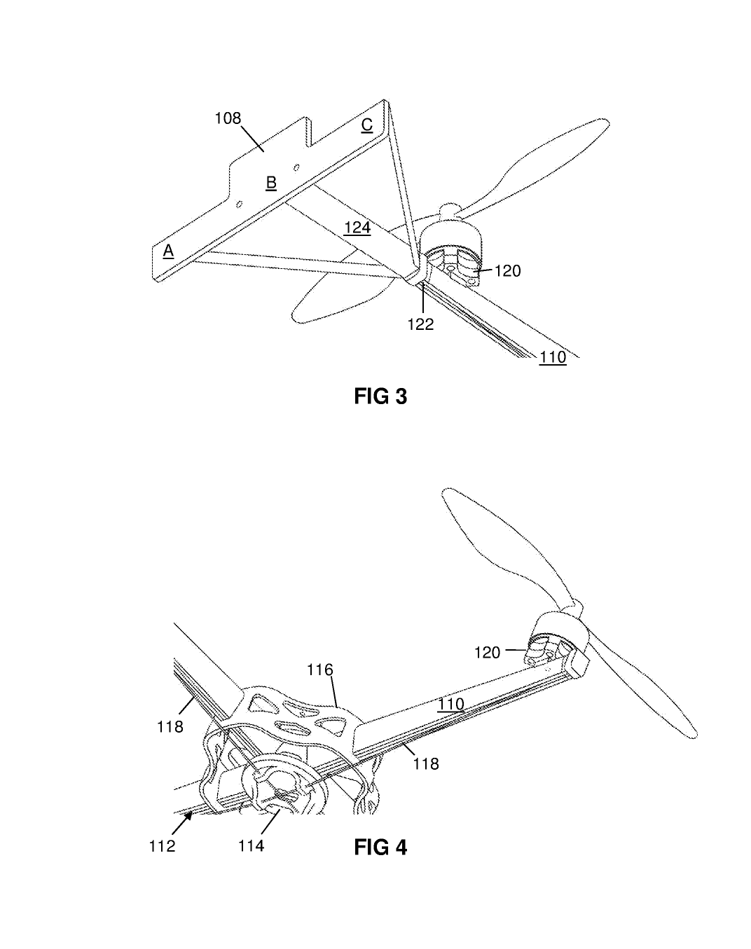

Constructional features of the UAV 100 may include the following:
A frame weight of approximately 200 g.
A motor-to-motor distance of approximately 400 mm
Aerodynamic profiles for components of the airframe 102, for example the frame arms 110, to improve efficiency in the propeller down-wash.
Slots (112, FIG. 4) defined in frame arms 110; these slots allow for motor power cables to be mounted out of the way.
A central boss (114, FIG. 4) for internal strength.
An external hub 116 radially spaced from the boss 114, for additional strength and rigidity.
Horizontal stay wires 118 extending under tension between the central boss 114 and the ends of the frame arms 110, to brace the frame and enhance vertical rigidity.
Motor mounts (120, FIG. 3) machined from aluminium for heat dissipation. The motor mounts 120 can be mounted on aluminium inserts (122, FIG. 3) friction fitted inside the ends of the frame arms 110 and secured by means of small locating screws. The inserts 122 typically define fastening formations such as screw holes (not shown), for fastening the motor mounts 120 to the inserts 122.
Fastening formations (not shown) defined in the motor mounts 120 and/or inserts 122, for mounting accessories like sensor mounts, barcode scanner mounts, bumper arms, extension booms and the like on the end of the frame arms 110.
The mounting plate 108. This serves as a mount for at least one front mount scanner and sensors (not shown). Possible locations of these devices on the mounting plate 108 are shown in FIG. 3. Reference letters A, B and C indicate, respectively, exemplary positions of an ultrasonic sensor, scanner (or plurality of scanners) and infrared sensor respectively.

The mounting plate 108 is connected to an extension boom 124 fixed to the end of one of the motor arms or frame arms 110, to bring the scanner closer to the racking in use, and also move the sensors away from the motor 104 thereby to reduce acoustic interference with the ultrasonic sensor (not shown). A scanner assembly (not shown) may include housings for scanners, sensors and antennae. The scanner assembly typically houses an RFID scanner, a barcode scanner and a range sensor. The scanner assembly is movable, and the linkage of the scanner assembly may be adjustable to provide scanning at different angles.

Motor and propeller shrouds are omitted from preferred embodiments of the airframe 102 on account of their extra weight. However, shrouds may be implemented in selected versions as they can enhance safety, provide impact protection in the case of slight contact with an obstacle, and improve airflow and flight efficiency.

A battery (not shown) is accommodated at one end of the UAV 100. The location and weight of the battery are typically arranged to counterbalance other heavy components of the UAV 100.

The propellers 106 are preferably designed with safety in mind They may be shatter resistant.

In certain alternative embodiments of the invention (not shown), a single motor is provided instead of multiple motors. The single motor can be housed internally in the airframe near the center of the UAV, and four drive shaft housings may extend radially outwardly from the central motor to the locations of the four propellers. Appropriate linkages, couplings and drive shafts can be provided to transfer motive force from the central motor to the ends of the drive shaft housings where the propellers are mounted. Electronically controlled limited slip clutches may be used to control the propeller speeds.

The following elements are not individually referenced in the drawings but are important additional components of UAVs for use in the invention:
RFID scanner. This may be UHF (long range) or HF (close range) depending on the requirements of the warehouse. Close range RFID technology can be used for positional information.
Mounted barcode scanner—This can be a commercially available barcode scanner of the type used for scanning boxes in a warehouse. However, a bespoke, custom-designed barcode scanner is preferred. Typically the scanner is mounted onto the front of the UAV. A robust, balanced and controllable mounting system for the scanner is advantageous, to limit vibrations and oscillations. The mounting system should project away from the airframe and can be adapted to carry various sensors in addition to the scanner. The mounting system may include gimbal systems with counterweights.
Links to the base station for the above. This includes transmission means for transmitting data and video footage from the UAV to a Base Station.
Operator inputs to the above.
Range detector. This may comprise infrared, sonar (ultrasonic) and/or optical flow sensors, or a laser range finder.
Position control means (or Position Controller). This is a critical feature of the UAV and of the airborne scanning system, and is discussed in greater detail below.
Height or altitude detector. This may comprise sonar (ultrasonic), optical flow or laser sensors, and/or an altimeter. Altimeters based on barometric sensors are less preferred as their accuracy is normally only to within 30 cm or more. Infrared sensors are accurate to within a few centimeters but only up to a range of approximately 2 m.
An FCU for flight control. The FCU may be housed in a FCU housing adapted to reduce vibrations. It is typically located towards the center of the airframe to protect it from damage. The FCU may include gyroscopes and accelerometers (e.g. a 3-axis accelerometer). Typically these cooperate with one another in an Inertial Measurement Unit (IMU) which forms part of the FCU. The FCU may run MultiWii software which uses readings from the accelerometers and gyroscopes to keep the UAV level. These readings are typically also sent to the listening position controller. The FCU may receive left/right/up/down instructions from the position controller.
   Multiwii Serial Protocol (MSP) can be used to send text messages to the FCU and to receive information from it. Serial commands are sent to the FCU over a serial port in MSP format. Two interactions are required with the FCU:
the position controller requires accelerometer data from the main FCU in order to calculate movement; and
the position controller will send navigation commands to the FCU in order to get the UAV to go where it needs to.

MSP can support both of these requirements.

In addition to the various elements of the UAV set out above, preferred embodiments of the UAV may also comprise the following components:
Mounted camera—At least one small camera can be mounted on the front of the UAV.

Cameras for both still and video images may be provided. The video camera is used to send a live video feed—for example a FPV—to the pilot who can then see where the UAV is facing and steer it. An anti-vibration camera mount may be provided to improve the quality of photographs and videos taken during flight. The camera mount may include carbon fibre or glass fibre components. A double anti-vibration design may be used.
A balanced airframe; an autonomous flight control system; a collision detection system; computer software for managing the scanning process; means for reading visual proximity indicators and/or navigation indicators to facilitate alignment and positioning of the UAV; a lightweight bumper system for the UAV (front, back, and sides).

To lengthen flying times it is preferable that the airframe and motors be made as light as possible, and that efficient batteries and motors are used.

### B: Base Station

This is a computer running specially designed data collection software that records the barcodes scanned, optionally in real time, and provides information used to monitor the accuracy of the stock take process. Advantageously the base station is mobile (it may, for example, comprise a laptop, notebook, tablet or other computer).

The Base Station receives the scanned information from the UAV and checks it against a database to ensure that everything is correctly scanned. Hardware and software may be included for carrying out on-the-fly warehouse management and feedback to the operator and UAV, informing them of the status of the data gathered and whether corrections or repeat scans are needed, and directing the UAV to its next location.

### C: Pilot Equipment

A pilot is an important requirement of the airborne scanning system except for those embodiments which are completely autonomous. Preferably the pilot wears goggles or spectacles that provide a First Person View of what the camera on the UAV sees. This allows the pilot to correctly line up the barcode scanner with the barcodes on the boxes. The pilot uses standard radio control (R/C) equipment to fly the UAV. Professional piloting skills are advisable for efficient operation of the system.

### D: Power Source

It is necessary to have a power source for powering the Base Station and for charging onboard and spare batteries for the UAV and the R/C equipment. Multiple batteries are typically required for operation of the system, because of the relatively short flying times of multi rotors (typically of the order of 10 minutes).

Two important aspects of the invention will now be discussed in greater detail: firstly, the position control means (or position controller) and thereafter, the subject of indoor navigation of the UAV.

### Position Controller

The positioning system of the UAV ensures that the UAV is positioned in the correct location in order to read the barcodes/RFID tags on the boxes in the warehouse.

In one embodiment, the system is designed to navigate in two dimensions, i.e. up and down and left and right, the system will maintain a fixed distance from any objects in front of it, it is not intended that it needs to navigate backwards and forwards. This is suitable for large warehouses with uniform racking and uniform items on the racks.

The positioning system will allow the UAV to navigate around small sections of the warehouse, in a limited range from many fixed reference points. The UAV will be guided to fixed reference points by navigating to fixed height levels above the floor (the shelves of the racks). It will then navigate along those heights until it finds a fixed reference point (a barcode or RFID label on the racks).

Once the fixed reference point is found, the UAV will fly up, and left and right from that point, maintaining a fixed distance away from objects in front of it, until it finds the barcode(s) of the items on that shelf.

The position controller takes various inputs and directs the UAV's flight path to ensure that it correctly scans a pallet's barcode and associated bin location information.

The position controller provides precise indoor navigation without the need for fixed guidance infrastructure such as indoor GPS beacons or infra-red beams. In one embodiment it comprises a microprocessor running embedded C++ code and can take inputs from:
Height Sensors
Range sensors
RFID scanners
Barcode scanners
Preset settings
Operator adjustments
Base station commands
The FCU

The position controller processes all of the above inputs and works out where the UAV must move to next. It continuously adjusts the UAV's desired location in space based on what inputs it receives. For example, once the final barcode in a bin has been scanned it moves upwards until its height sensor reaches the racking height. Once the racking height is reported by the height sensor, it tells the FCU to move left or right, depending on what the base station tells it is the racking configuration (the base station having read this information from a database).

In order to find its reference point and reference levels, and perform the up and left and right search, the UAV needs to perform the following functions:

### Height

Maintain a constant height above the ground. The accuracy must be 1 cm. The range must be between 1 m and 10 m. The height needs to be accurately known in order for the UAV to find its reference point being a bin location barcode or RFID code stuck onto the shelf below the bin location. To measure height above the floor, an ultrasonic, laser, or optical flow sensor could be used. Barometric sensors could also be used however their accuracy is normally only to within 30 cm or more. Ultrasonic range finders are lightweight, low power, and well developed but they are not available for ranges over 10 m. Laser devices are accurate over a wide range but they are expensive, not well developed and heavy. Optical flow sensors may be useful for detecting lateral motion especially when combined with floor markings. Infrared sensors rely on detecting the amount of light being bounced back off reflective materials; they are accurate to a few centimeters but only up to a range of approximately 2 m.

### Separation

Maintain a constant distance away from objects in front of it. The constant distance is maintained in order to not crash into the racking and boxes and also to keep an optimum distance away for barcode scanning. The minimum distance must be 15 cm and the maximum 30 cm. It must also detect a “void”—where there is nothing in front of it within 1 m. If a void is detected, it must not rush into the void but maintain its position. Forward facing ultrasonic or infrared range sensors can be used here due to the short distance to be measured.

Due to the open space in a warehouse it is not anticipated that lateral range finders for collision avoidance are needed. In the case where racking is up against the side wall of the warehouse, or there are supporting pillars inside the warehouse, manual intervention (e.g. by radio control) will be needed to prevent collision in those areas.

### Orientation

Orientation (also called “yaw” or “heading”) means that the UAV must not point in a different direction than the direction of the barcodes to be scanned or else it will not be able to scan the barcodes correctly, and because it will continually want to move away from the racking.

There are a number of ways to ensure the UAV is orientated correctly:
The operator can align the device manually in the correct direction (e.g. by radio control). Most UAV's come with automatic sensors to prevent yaw and it will generally adjust yaw by itself to maintain a constant heading.
Magnetometers on the UAV's flight control board (FCU) can also be activated however they might be susceptible to interference from metal racking as well as certain components of the UAV and high current drawn by the UAV for its motors.
Two forward facing ultrasonic or infrared range finders could be used and the UAV could adjust its heading until both provide the same reading.

### Lateral Movement

The position controller will need to determine how far the UAV has moved from its fixed reference point. The “up” movement can be accurately determined using the height sensor mentioned above; however other methods are needed to determine the left and right movement, for example:
Gyroscope/Accelerometers: a combination of these devices is called an “Inertial Measurement Unit” (IMU). By integrating acceleration, a distance can be calculated.
Optical flow sensors: an optical flow sensor is a camera-type device that measures the speed of items moving in front of it.
Markings on the ground and an optical sensor reading those markings.
Other fixed methods e.g. mounting beacons within the warehouse.
   Table 1 (below) lists selected key tasks that a UAV needs to perform, along with the required accuracy that the position controller needs to be able to maintain for these tasks:

TABLE 1
UAV Tasks and Accuracy Tolerances Required

| Task | Range/Accuracy |
|---|---|
| Maintain distance from racking | 30 cm ± 2 cm |
| Maintain distance from pallets | 30 cm ± 5 cm |
| Maintain height | 10 m ± 2 cm |
| Find navigation indicators | 3 m ± 5 cm |
| Find barcode | 6 m² |
| Relocate to next bin | 2 m ± 5 cm |

As an example, the position controller can continuously tell the UAV to move forwards or backwards to keep the desired 30 cm range from the racking.

Advantageously the position controller is designed in accordance with “fuzzy logic” principles because it will not know exactly where to go when seeking its barcode and location indicators. It might also be acceptable to scan pallet barcodes out of order in which case the fuzzy logic should allow for that and possibly use more than one navigation or location indicator to determine which pallets have been scanned.

It is not anticipated that navigation or location indicators need to be positioned all around each bin location—this would be onerous to set up. Rather, a bin can be confined by an upper and lower height reading and all barcodes within a loosely defined area above that bin can be considered to be within that bin location.

The code running on the position controller (which is typically located onboard the UAV) is designed in a flexible, scalable and maintainable manner. As such the code is preferably designed using object orientated programming (“OOP”) techniques and coding standards (as opposed to a sequential program design). This allows areas of the program to be changed easily and quickly without affecting other areas. It also allows for easy addition of other sensors or components, and because it is modular, it allows for different people to work on different areas of the program at the same time.

Examples of the class design and main control loop of the software are discussed below.

In FIG. 5, reference numeral 500 indicates generally a partial object model showing some of the classes that may be required by the position controller in order to perform its functions.

The following classes implement the iSensors interface 501:

RangeSensor 502; FCUGyrosensor 503; HeightSensor 504.

The following classes implement the iScanners interface 505:

BarcodeScanner 506; RFIDScanner 507.

The following additional classes are provided:

PositionController 508; FCUCommander 509.

Table 2 (below) sets out the class design in more detail:

TABLE 2
Class Design

| Get Readings | Get Settings |
|---|---|
| Get Height | Get Current Rack Height |
| Get Front Distance Left Arm | Get Search Position |
| Get Front Distance Right Arm | (up/down/left/right) |
| Get Accelerometer and Gyroscope | Get Search Size (width/height) |
| | Get Next Position |
| Position Calculator | Control |
| Integrate Accelerometer and Gyroscope | Calculate Height, Left/Right & |
| Calculate height | Forward Movement |
| Calculate left/right distance | Send to FCU |
| Calculate yaw | |
| Check for reasonableness | |

The routines in Table 2 identified with a single border will need to be performed continuously. The routines in Table 2 identified with a double border will need to be performed at key points—they define parameters sent from the base station.

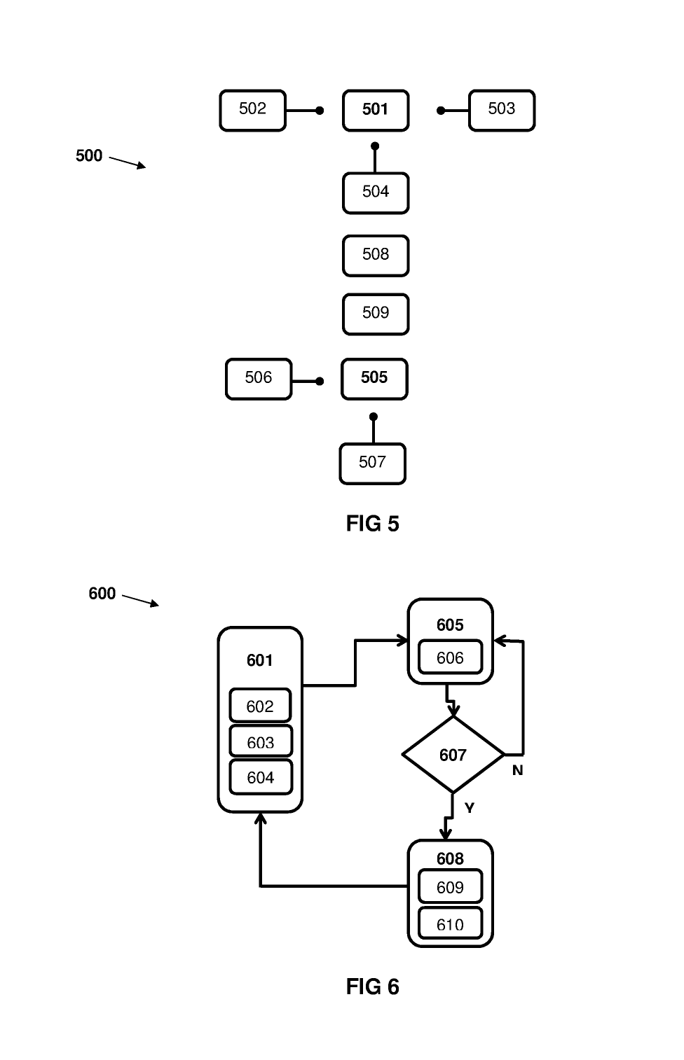

The flowchart 600 shown FIG. 6 is incorporated herein by reference. The steps shown in the FIG. 6 flowchart will be performed when finding items. These steps call on the Table 2 routines which are shown within a single border, and the same routines respond according to what transpires in the flowchart.

The routines of Table 2 are discussed in more detail in the following:

### Get Readings

This block of functions will read data from the following sensors:
a) The height above ground from the downward facing sonar,
b) The distance to objects from the IR, sonar (ultrasonic) and/or laser sensors on each front arm (IR are lightweight, low power and good for close distances)
c) The acceleration and angle from the gyro and accelerometer on the FCU.
   Position Calculator (“Pos. Calc.”)

This is the position calculator software. It uses the sensor readings to calculate what adjustments must be made to the UAV.

a) The code will need to calculate distance from acceleration angle, and time. It will need to keep a running total of distance in 3 axes and reset this when a position indicator is detected.

b) The height will need to be calculated from the downward facing sonar readings.

c) The distance from objects in front needs to be calculated. In addition to this, some decisions need to be made if there is collision hazard and also if there is nothing in front to prevent the UAV flying forwards into voids.

d) The relative distance of both arms from the object in front of it should be calculated to see if yaw corrections need to be made. Over un-even surfaces (e.g. when around the places where there are gaps), yaw correction should not be made.

e) The reasonableness of the adjustment needs to be checked to see if it is perhaps an anomaly in the sensor readings or the UAV is flying past a gap in the racking or past a gap in a pallet. If the reading is unreasonable, the best thing the Pos. Calc. can do is to “pause” for a short period—say, half a second, and not send any new adjustments, rather let the UAV continue on its previous “reasonable” path.

f) The inputs of the position calculator are: sensor readings, the current control state (as previously calculated), and the desired position (obtained from the base station computer).

g) The outputs of the position calculator are: adjusted pitch, roll, yaw and throttle values to control the UAV.

### Control

The control block is responsible for sending control commands to the UAV. It will convert the required adjustments into actual pitch, roll, yaw and throttle values that will move the UAV in one particular direction.

### Get Settings

This code is responsible for getting settings from the base station computer over a radio signal.

a) The expected height of the racking will be obtained from the computer, this assists the scanner in finding its next position indicator.

b) The location of the next box to scan relative to the UAV's current location will need to be known, this is so that the UAV knows whether to fly up, down left or right depending on the racking layout.

c) The search size is how far the UAV is allowed to fly when searching for a barcode, this would be equivalent to the size of a box, or loaded pallet, or bin location.

d) The location of the next position indicator relative to the UAV's current location will need to be known, this is so that the UAV knows whether to fly up, down left or right depending on the racking layout, in order to find its next position indicator.

The flowchart 600 is discussed in more detail in the following, with reference to FIG. 6:

### Find Position (Step 601)

This code will move the UAV left and right along a determined height until it finds a barcode or RFID position indicator. When the special position indicator is scanned, it is sent to the computer and the UAV will then proceed to search for the box in the position defined by the computer.

Steps 602, 603, 604 represent, respectively, “Go to current rack height”, “Go left and right until find position”, and “Reset distance.”

### Find Barcode (Step 605)

This will make the UAV fly in within a pre-defined range and search for a barcode. It will need to do some rudimentary checks on the barcode and send it to the base station for validation. Once found, the base station will tell it where to go next, either to find another position indicator or to find another barcode in the same bin location.

Step 606 represents “Fly within search square.”

The decision diamond 607 contains a conditional: “Barcodes done?”

### Find Next Position (Step 608)

This logic tells the UAV to move on from where it is and go (down and then left or right) to the predefined racking level and move up and down within a pre-defined range until it finds a position indicator.

The steps 609, 610 represent, respectively, “Go towards next position” and “Go to next rack height.”

In addition to the software for the position controller, the airborne scanning system also typically includes other software and hardware for carrying out functions related to:
identifying the position of boxes;
checking the number of boxes scanned and reconciling these figures; and
integrating scanned data into an organization's stock take programme

### Indoor Navigation

Indoor navigation functionality of the UAV is provided to navigate the UAV around racking in a warehouse environment, and to seek and scan barcodes (and/or RFID codes) on pallets and bin locations on racking. A navigational accuracy of 5 cm is desirable to prevent collisions during autonomous flight.

GPS on its own is not suitable for indoor operations as it does not generally function indoors without highly sensitive equipment and expensive fixed installations. Also, it cannot provide the above-mentioned level of accuracy required for autonomous flight. However, GPS may be combined with an indoor positioning system (“IPS”) in an IPS/GPS hybrid solution. IPS uses RF, WiFi, Infra-red or camera image processing techniques.

An IPS/GPS could provide bin location information to the UAV. An IPS/GPS system for the present application may include the following technologies, amongst others:
fuzzy-logic search functionality to assist in locating barcodes on a particular pallet (since a barcode could be positioned anywhere on a pallet within a 6 m² area);
on-board processing means to keep scanners a predetermined distance from the racking (and the boxes to be scanned), to ensure successful barcode and RFID scans, and to avoid collisions;
means for accurately determining UAF height or altitude, which is essential in determining the correct bin location;
magnetic sensors;
a barometric pressure sensor; and
a GPS sensor.

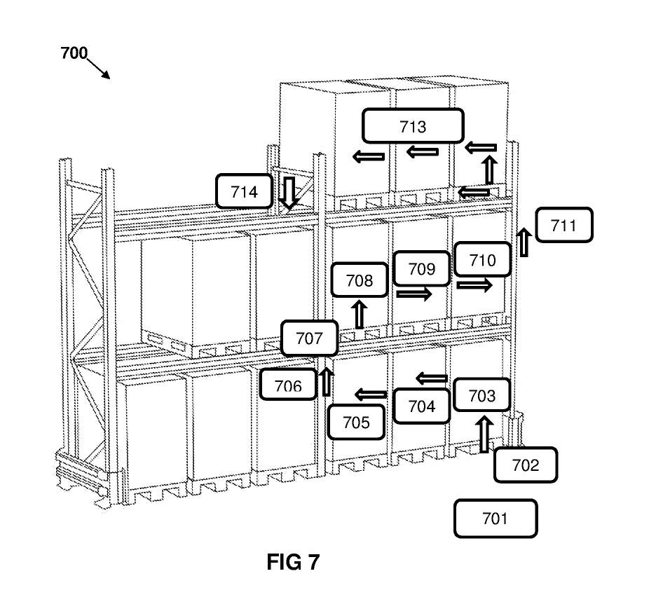

In FIG. 7, reference numeral 700 indicates one possible example of the navigational steps performed by a UAV which is carrying out its tasks along a section of racking. The step numbers in the description below correspond to the numbers on the drawing, and refer to the following navigational steps:

Step 701: An operator positions the UAV at its first bin location on the ground in front of the first rack and gives it a remote activation command to initialize it. The base station already knows the initial location because the warehouse will be navigated in a predetermined sequence.

Step 702: The UAV takes off and positions itself a required distance from the pallets in front of it, at an estimated height corresponding to the first row of barcode labels above the ground (a preset height of the barcode will have been provided to the UAV, controlled by the base station).

Step 703: The UAV seeks the first barcode by making small movements in a zone limited to a certain distance from its take-off point, all the while maintaining an optimal distance from the pallet in front of it.

Step 704: Once the first barcode is scanned the UAV seeks the second barcode by moving a preset distance to the left and making small movements within that zone to find the second barcode.

Step 705: Once the second barcode is scanned it moves again to the left and seeks the third barcode.

Step 706: Once the three barcodes for that bin location have been scanned (the number of expected barcodes will be a setting controlled from the base station), it relocates to the first racking level.

Step 707: Once at the first racking level, it seeks a location indicator by making small left and right movements along the racking while retaining its height.

Step 708: Once the location is found, the UAV moves up to the expected height of the next level of barcodes. It has to move up because the barcodes are typically positioned higher the shelves or platforms of the racking. The expected height will have been preset and made available by the base station. The UAV then makes small movements in that zone to find the fourth barcode, while maintaining an optimal distance from the pallet in front of it.

Steps 709 & 710: Once the fourth barcode is found, the next two barcodes are found by relocating to the right and making movements in that zone.

Step 711: The UAV then moves up to the second level of racking and maintains that height.

Step 712: Once at the second racking level, it seeks a location indicator by making small left and right movements along the racking while retaining its height.

Step 713: It then climbs to the expected height of the next level of barcodes and seeks the additional barcodes.

Step 714: The UAV repeats this procedure for the next horizontal section of racking; however in this case it moves from the top down, to limit the energy needed for relocation.
Operator input may be required to indicate “missing” boxes. This allows the scanner to move onto the next racking level. Alternatively, the range sensor can be used to indicate missing boxes.
The system has settings configured for each warehouse. Typically a once-off setup is needed for each warehouse. The settings are saved in a database for easy future retrieval. The UAV can have different settings uploaded to it from the base station, depending on what racking it is busy with.
The system settings typically include: racking level heights, estimated barcode heights, number of barcodes per location, and number of racking levels.
The location indicators may include RFID tags or barcodes adhered to the racking. Experimentation can be carried out to determine which option works best. The advantage of RFID tags is that the RFID scanner can have its power turned down for close range scanning, and it can be configured to automatically increase its power to search a larger and larger range. The advantage of barcodes is that they are cheap, and some racking already has barcodes on it.
In less sophisticated embodiments of the invention the system can be made to work without the location indicators on the racking, by using a more manual process. The UAV still has the preset height functionality as well as the range sensor to keep it at the same distance from the pallets or racking; however an operator provides the movement trigger remote control, e.g. by flicking a manual switch. The database provides the bin location according to a preset sequence, as long as a preset path is flown.

### Manufacture

Manufacture of the UAV can be carried out using materials and techniques known to those skilled in the art. However, the following guidelines are proposed by way of non-limiting example.

Suitable materials include carbon fibre cloth, epoxy resin, aluminium, carbon fibre tubing, expanding foam resin, additional plastic components, steel and nylon fasteners, copper wire, a flight control power system (sub-assembly), flight control electronics (sub-assembly), radio control electronics (sub-assembly), and a battery.

To set up for manufacture, the following steps may be followed:

A CAD 3D model of the airframe can be created and used as the basis for a CNC cutter to cut moulds out of wood, nylon and plastic. Silicone moulding rubber can be used for additional moulded components. CAD and CNC can be used to cut the motor and scanner mounting from aluminium. Jigs for assembly, finishing and testing can then be created.

The individual airframes can be manufactured by vacuum forming airframe shells over the above moulds using carbon fibre and/or glass fibre and epoxy resin, and subsequently injecting foam into the shells. The scanners, motors, FCU and speed controllers can be mounted. The power wiring loom can then be soldered and the software for the FCU can be loaded. Periodic quality control must be performed systematically.

Those skilled in the art will appreciate that there are various ways of putting the invention into practice other than the specific examples disclosed herein.

### INDUSTRIAL APPLICABILITY

The airborne scanning system and the other aspects of this invention are suitable for many applications involving the scanning of data records such as barcodes and RFID codes. One of the applications for which the invention is particularly important, is the carrying out of indoor stock takes in warehouses. However, the invention is not restricted to this type of application. The invention can be used in any field requiring the scanning of data records, and especially for the scanning of records at inconvenient heights. Thus, the invention may also be suitable for use in industries such as transport and shipping, where, for example, it may have applicability in the scanning of goods or containers in port or loaded onto ships.

1. A scanning system for scanning data from a plurality of data records that are mutually spaced from one another within a predetermined zone of operation defined by a zone structure having a zone geometry, said zone of operation defining discrete stock storage locations for the storage of stock items, each said stock storage location being provided with an associated location data record which defines data (“location data”) that is unique within the zone of operation, and at least some of said stock items each being provided with an associated stock data record which defines data (“stock data”) that is unique within the zone of operation, wherein said system comprises:
a database containing a 3-dimensional plan of at least a portion of the zone geometry of said zone structure;
at least one Unmanned Aerial Vehicle (UAV);
at least one scanner mounted on said UAV and adapted to scan said location and stock data records thereby to extract the location and stock data, respectively, from said data records;
correlation means for assigning the extracted stock data for each stock item to the extracted location data and for storing the stock data and location data in the database; and
a position controller for controlling the position of the UAV within the zone of operation, said position controller having:
a) means for receiving input from the database regarding the 3-dimensional plan;
b) means for receiving input from database regarding the location data;
c) processing means including at least one microprocessor; and
d) software adapted to be executed by said microprocessor, for comparing said location data against said 3-dimensional plan and generating navigational commands for the UAV.

2. The scanning system as claimed in claim 1, wherein the zone structure is a warehouse.

3. The scanning system as claimed in claim 1, wherein the UAV is provided with at least one range sensor for determining the UAV's range relative to at least a portion of the zone structure, and the position controller includes means for refining the UAV's position within the zone of operation by comparing said range to the 3-dimensional plan.

4. The scanning system as claimed in claim 1, wherein said system includes a mobile base station comprising data processing means and data collection software, for recording the extracted data from the scanned data records.

5. The scanning system as claimed in claim 1, wherein said data records are selected from the group consisting of barcodes and close range Radio Frequency Identification (RFID) tags.

6. The scanning system as claimed in claim 5, wherein said data records are barcodes.

7. The scanning system as claimed in claim 1, wherein said system includes ancillary components selected from the group consisting of:
autonomous flight control means for controlling the flight and scanning operations of the UAV according to predetermined patterns;
altitude detection and control means;
collision detection means;
processing means and computer software for managing operation of said scanner; and
a plurality of visual proximity indicators to serve as location indicators, with proximity measuring means mounted on said UAV for reading said visual proximity indicators.

8. A position controller for controlling the position of an Unmanned Aerial Vehicle (UAV) within a zone of operation defined by a zone structure having a zone geometry, said UAV forming part of a scanning system which includes:
a Flight Control Unit (FCU); and
data input sources comprising (a) a database containing a 3-dimensional plan of at least a portion of the zone geometry of said zone structure, (b) location data records distributed within the zone of operation, each such location data record defining data (“location data”) that is unique within the zone of operation, and (c) at least one range sensor mounted on the UAV for determining range data representing the UAV's range relative to at least a portion of the zone structure;
said position controller comprising:
processing means including at least one microprocessor;
software adapted to be executed by said microprocessor, for receiving and processing input from said data input sources, and for comparing the location data and the range data against said 3-dimensional plan, thereby to determine a location of the UAV within the zone of operation and a location within the zone of operation to which it should next move, and to generate flight control and navigational commands for the FCU;
the position controller further comprising data transmission means for transmitting said flight control and said navigational commands to the FCU for subsequent implementation by the FCU, thereby to control the UAV's navigation within the zone of operation.

9. A method of scanning a plurality of data records which are mutually spaced from one another within a zone of operation defined by a zone structure having a zone geometry, said zone of operation containing a plurality of stock storage locations for storage of stock items, characterized in that said method comprises the following steps:
compiling a 3-dimensional plan of at least a portion of the zone geometry of said zone structure;
providing a plurality of stock location markers, each said stock location marker comprising a data record which defines data (“location data”) that is unique within the zone of operation;
pre-positioning said stock location markers on the zone structure proximate said stock storage locations;
cross-referencing the positions of the stock location markers within the zone of operation, with their corresponding positions in the 3-dimensional plan, thereby to establish a plurality of fixed reference points within the zone of operation;
storing the 3-dimensional plan and the cross-referenced positions of the stock location markers in a database;
providing an Unmanned Aerial Vehicle (UAV) which includes at least one scanner adapted to scan said data records thereby to extract data from said data records;
operating said UAV;
scanning at least one of said stock location markers with said scanner thereby to extract its unique location data;
interrogating the 3-dimensional plan to correlate said unique location data with one of said fixed reference points, thereby to establish a current approximate position of the UAV within the zone of operation; and
calculating a subsequent position for the UAV within the zone of operation, using its current position as a starting position, and navigating said UAV to said subsequent position.

10. The method of scanning as claimed in claim 9, wherein said method comprises the following additional steps:
providing at least one range sensor mounted on the UAV and operating it, thereby to obtain range data representing the UAV's range relative to at least a portion of the zone structure; and
comparing said range data against the 3-dimensional plan contained in the database.

11. The method of scanning as claimed in claim 10, wherein said UAV is provided with at least one position controller, at least one Flight Control Unit (FCU) and data input sources including at least one height sensor, characterized in that said method includes the following additional steps:
operating said FCU under command from the position controller, thereby to fly the UAV in a generally vertical direction until a predetermined height is reached, as determined by input received from the height sensor and processed by said position controller;
operating said FCU under command from the position controller, thereby to fly the UAV in a first generally horizontal direction while scanning with said scanner until a stock location marker is detected by said scanner;
extracting the unique location data from said stock location marker using said scanner;
interrogating the 3-dimensional plan using the unique location data of said stock location marker, thereby to determine the fixed reference point corresponding to said marker; and
operating said FCU under command from the position controller, thereby to fly the UAV in a second generally horizontal direction aligned transversely to said first generally horizontal direction.

12. The method of scanning as claimed in claim 11, wherein the data records are located according to a spatial configuration, characterized in that said method comprises the following additional steps:
providing a base station in spaced relation to the UAV, said base station being adapted to access information regarding said spatial configuration of the data records;
interrogating said base station to access said information;
transferring said information to the position controller; and
operating the position controller in such a manner that said information is included in its determinations regarding the flight of the UAV in at least one of said directions.

13. The method as claimed in claim 9, in which said data records are selected from the group consisting of barcodes and close range Radio Frequency Identification (RFID) tags.

14. The method as claimed in claim 13, wherein said data records are barcodes.

15. The method as claimed in claim 9, wherein the zone structure is a warehouse.

16. The method as claimed in claim 9, which includes the steps of:
associating at least some of the stock items each with a stock data record which defines data (“stock data”) that is unique within the zone of operation;
scanning at least one of said stock data records thereby to extract its unique stock data;
assigning the extracted stock data for said stock item to one of said fixed reference points; and
storing said unique stock data in the database.
